(19) United States
(12) Patent Application Publication
(10) Pub. No.: US 2015/0254099 A1
(43) Pub. Date: Sep. 10, 2015

(54) Software Enabled Network Storage Accelerator (SENSA) - Hardware Real Time Operating System (RTOS) Optimized for Network-Storage Stack applications

(71) Applicant: Riverscale Ltd, Kfar Saba (IL)

(72) Inventors: Vitaly SUKONIK, Katzir (IL); Evgeny SHUMSKY, Petah Tikva (IL)

(73) Assignee: Riverscale Ltd, Kfar Saba (IL)

(21) Appl. No.: 14/201,954

(22) Filed: Mar. 10, 2014

(51) Int. Cl. G06F 9/48; G06F 9/50

(52) U.S. Cl. CPC G06F 9/4806; G06F 9/4881; G06F 9/5027

(57) ABSTRACT

A Software Enabled Network Storage Accelerator (SENSA) system includes a number of SENSA components. The components can be implemented individually or in combination for a variety of applications, in particular, data base acceleration, disk caching, and event stream processing applications. Hardware (HW) real time operating system (RTOS) optimization for network storage stack applications such as event processing avoids conventional CPU usage by processing the payload, or internal data, of a packet using an array of at least two event processing elements (EPEs), each EPE in the array configured for: receiving events, each of the events having a task corresponding to the event; and processing the task in run-to-completion manner by operating on some portions of the task and offloading other portions of the task.

### FIELD OF THE INVENTION

The present invention generally relates to storing digital data, and in particular, it concerns accelerating network storage of digital data.

### BACKGROUND OF THE INVENTION

Conventional event processing is performed by a general purpose CPU (central processing unit) for processing, retrieving, and returning requested data blocks. Processing is relatively slow, as compared to the processing times demanded of modern users to return requested data, in particular from a remote server/remote storage. There is therefore a need to accelerate network storage of digital data.

### SUMMARY

According to the teachings of the present embodiment there is provided a system including: an array of at least two event processing elements (EPEs), each EPE in the array configured for: receiving events, each of the events having a task corresponding to the event; and processing the task in run-to-completion manner by operating on a first portion of the task and offloading a second portion of the task.

In an optional embodiment, all EPEs in the array are identical. In another optional embodiment, all EPEs in the array are configured with identical instruction code for execution. In another optional embodiment, each EPE in the array is a RISC core. In another optional embodiment, the array of EPEs includes a multitude of EPEs. In another optional embodiment, wherein each the EPE is configured to receive single the events sequentially. In another optional embodiment, each EPE includes firmware configured to implement the operating on the any portion of the task.

In another optional embodiment, the first portion of the task includes functions selected from a group consisting of: classification of received events; deciding on a priority for each received event; arbitrating decisions regarding hardware processing engines (HWEs); and main processing functionality.

In an optional embodiment, the system further includes an event distributor for receiving the events and distributing the events among the EPEs. In another optional embodiment, the event distributor is configured with a round robin tasks dispatcher algorithm to distribute events to each EPE in the array of EPEs.

In an optional embodiment, the system further includes an input events scheduler for: receiving the events as input; scheduling processing of the events; and sending the events as output to the event distributor.

In an optional embodiment, the system further includes an on-chip buffer including at least one memory selected from the group consisting of: an events payload storage memory; and a temporary storage configured for transfers between disk and network wherein each EPE has direct load and store access to the on-chip buffer.

In an optional embodiment, the system further includes an input events queue wherein a number of the EPEs in the array exceeds a maximum number of unclassified events allowed to be waiting to be serviced in the input events queue.

In an optional embodiment, the system further includes a hardware engine module including an array of a plurality of hardware engines (HWEs) configured for processing requests from the EPEs, to which the second portions of the tasks are offloaded.

In an optional embodiment, the HWEs are configured for performing functions selected from the group consisting of: table lookups; internal table lookups; external table lookups; hash calculations; hash SHA-1; hash MD-5; hash AES; link list exploring; session context handling; and transaction context handling;

In an optional embodiment, the system further includes a DRAMs (dynamic random access memory) interface module operationally connected to the hardware engine module and including modules selected from the group consisting of: interface modules; external DRAM interfaces; memories; and internal tables.

In an optional embodiment, the system further includes a volatile memory module operationally connected to the DRAMs interface module and including at least one volatile memory. In another optional embodiment, the volatile memory is a DRAM module.

In an optional embodiment, the system further includes an output actions queues module operationally connected to the array and configured for receiving output from the EPEs. In an optional embodiment, the system further includes an output actions scheduler module operationally connected to the output actions queues module and configured for receiving output from the output actions queues module.

According to the teachings of the present embodiment there is provided a method for processing events including the steps of: receiving events, each of the events having a task corresponding to the event; and processing the task in run-to-completion manner by operating on a first portion of the task and offloading a second portion of the task.

In an optional embodiment, each received event is processed by identical instruction code. In another optional embodiment, each of the events is received sequentially.

In another optional embodiment, the first portion of the task includes functions selected from a group consisting of: classification of received events; deciding on a priority for each received event; arbitrating decisions regarding hardware processing engines (HWEs); and main processing functionality.

In another optional embodiment, the events are received from an event distributor. In another optional embodiment, the event distributor transmits the events based on a round robin tasks dispatcher algorithm. In another optional embodiment, the events are received at the event distributor from an input scheduler configured for: receiving the events as input; scheduling processing of the events; and sending the events as output to the event distributor.

In another optional embodiment, the second portion is offloaded to a hardware engine (HWE) module. In another optional embodiment, the HWE module is configured for performing functions selected from the group consisting of: table lookups; internal table lookups; external table lookups; hash calculations; hash SHA-1; hash MD-5; hash AES; link list exploring; session context handling; and transaction context handling;

In another optional embodiment, processed events are transmitted to an output actions queues module.

According to the teachings of the present embodiment there is provided a computer-readable storage medium having embedded thereon computer-readable code for processing events, the computer-readable code including program code for: receiving events, each of the events having a task corresponding to the event; and processing the task in run-to-completion manner by operating on a first portion of the task and offloading a second portion of the task.

According to the teachings of the present embodiment there is provided a computer program that can be loaded onto a server connected through a network to a client computer, so that the server running the computer program constitutes an array of EPEs in a system according to any one of the above claims.

According to the teachings of the present embodiment there is provided a computer program that can be loaded onto a computer connected through a network to a server, so that the computer running the computer program constitutes an array of EPEs in a system according to any one of the above claims.

### BRIEF DESCRIPTION OF FIGURES

FIG. 1 is an exemplary reference diagram of retrieving of data over a network.

FIG. 2 is a high-level diagram of an exemplary Software Enabled Network Storage Accelerator (SENSA) implementation.

FIG. 3 is a more detailed diagram of an exemplary Software Enabled Network Storage Accelerator (SENSA) implementation.

FIG. 4 is a high-level partial block diagram of an exemplary system configured to implement a server of the present invention.

### ABBREVIATIONS AND DEFINITIONS

For convenience of reference, this section contains a brief list of abbreviations, acronyms, and short definitions used in this document. This section should not be considered limiting. Fuller descriptions can be found below, and in the applicable Standards. Bold entries are generally specific to the current description.

ACK—Acknowledgement

BW—Bandwidth.

CISC—Complex instruction set computing.

CPU—Central processing unit.

DB—Database.

DMA—Direct memory access.

DRAM—Dynamic RAM (random access memory).

ED/PM—Event distributor and power manager module.

EPE—Event processing element module.

Event—Payload of a received packet, explicitly or implicitly requesting the performance of an associated task.

HANA—“High Performance Analytic Appliance”, an in-memory, column-oriented, relational database management system developed and marketed by SAP AG.

HASH, hash—an algorithm that maps data of variable length to data of a fixed length. The values returned by a hash function are called hash values, hash codes, hash sums, checksums, or simply hashes.

HW—Hardware.

HWE, HW engine—Hardware engine.

I/F—Interface.

I/O, IO—Input/output.

IP—Internet protocol.

L1, L2, L3, L4, L5, L6, L7—levels of the OSI (open systems interconnect) networking model.

LAN—Local area network.

MAC—Media access control. Can be an OSI L2 protocol.

MD5—A type of hash algorithm.

NDDMA—Network-disk DMA (direct memory access).

NIC—Network interface card.

NPU—Network Processing Unit.

OSI—Open systems interconnect.

PCIe—PCI Express (peripheral component interconnect express), a high-speed serial computer expansion bus standard.

RAM—Random access memory

RD—Read.

RDMA—Remote DMA (direct memory access). A network offload engine. Enables a network adapter to transfer data directly to or from application memory, eliminating the need to copy data between application memory and the data buffers in the operating system.

RISC—Reduced instruction set computing.

RoCE—RDMA over converged Ethernet. A network offload engine. A link layer (L2) network protocol that allows remote direct memory access over an Ethernet network.

RTOS—Real time operating system.

SAS—Serial Attached SCSI. A point-to-point serial protocol that moves data to and from computer storage devices. Offers backward compatibility with some versions of SATA.

SATA—Serial ATA (advance technology attachment). A computer bus interface that connects host bus adapters to mass storage devices such as hard disk drives and optical drives.

SENSA—Software Enabled Network Storage Accelerator.

SHA-1—A type of hash algorithm.

SoC—System on a chip.

SVOE—Storage virtualization offload engine.

SW—Software.

TCP—Transmission control protocol.

TOE—TCP offload engine. A network offload engine used in network interface cards (NICs) to offload processing of the entire TCP/IP stack to a network controller.

WAN—Wide area network.

Wi-Fi, WiFi, WIFI—Wireless local area network (WLAN) products that are based on the Institute of Electrical and Electronics Engineers' (IEEE) 802.11 standards.

WLAN—Wireless local area network (LAN).

WR—Write.

### DETAILED DESCRIPTION

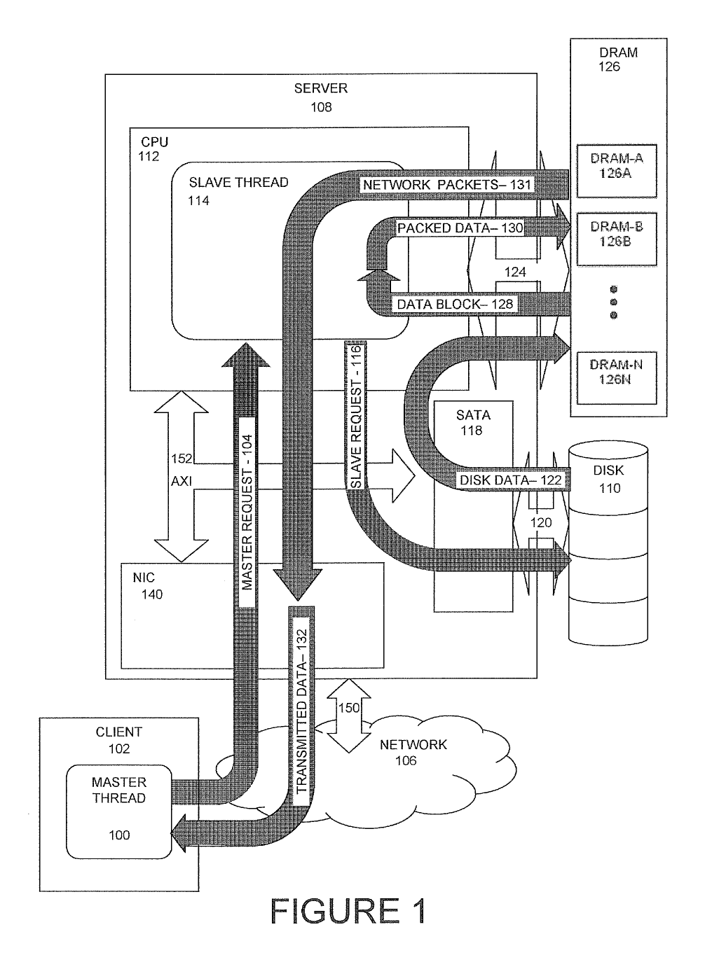

### FIGS. 1 to 4

The principles and operation of the system according to a present embodiment may be better understood with reference to the drawings and the accompanying description. A present invention is a system and methods for accelerating network storage of digital data.

In the context of this document, references to SENSA in general are to the general SENSA system that includes a number of SENSA components. The innovative SENSA components can be implemented individually or in combination. References to SENSA processing generally refer to processing by one or more SENSA components, as will be obvious from the context to one skilled in the art.

The SENSA architecture and components are suitable for a variety of applications, in particular, data base acceleration, disk-caching, and event stream processing applications.

Referring now to the drawings, FIG. 1 is an exemplary reference diagram of retrieving of data over a network. For clarity and simplicity in the current description, a typical case is used of a master thread 100 (also known as a client application or user application) on a client machine 102 requests data (master request 104) via a network 106 from a remote server 108 having associated storage (disk 110). The master request 104 is received at the server 108 by a NIC 140 and passed to CPU 112 running a slave thread 114 (also known as a server application). In general, processes are performed by the slave thread 114 using system calls as necessary to access the networking and storage stacks of the operating system (OS). Based on the received master request 104, the slave thread 114 generates and sends a slave request 116 to a SATA 118. The SATA accesses disk 110 via a SATA-disk connection 120 to retrieve the requested data. The SATA sends the retrieved disk data 122 via CPU 112 and CPU-DRAM connection 124 to a DRAM 126. A data block 128 is retrieved from DRAM 126 via CPU-DRAM connection 124, packed in the CPU 112 into packed data 130, and re-stored via CPU-DRAM connection 124 to DRAM 126. The packed data 130 is sent as network packets 131 to the NIC 140 for transmission as transmitted data 132 via the network 106 to the master thread 100 on the client 102. Server 108 includes one or more LAN connections 150 between the server and external networks (such as network 106) for receiving (such as master request 104), transmitting, (such as transmitted data 132), and other known networking functions. Server 108 also can include an internal bus 152 (such as an AXI bus in case of System-On-a-Chip—shown in the figure, or a PCIe bus in the case of a conventional server).

Data retrieval can begin with a remote request for data, in this case with a remote application (represented by master thread 100), sending a request for data (master request 104). On the server 108, receiving the master request 104 initiates invocation of the CPU client (slave thread 114). Typically, the CPU is interrupted and a network stack is generated for the disk block request. The slave thread 114 uses the CPU for hashing data received in the master request 104, in particular hashing the logical address of the data being requested. The resulting hashed value(s) are used via CPU-DRAM connection 124 to do a lookup in an address table in the DRAM 126. The lookup determines the physical address of the block(s) of data on disk 110. The physical address(s) of the data block(s) are sent as slave request 116 to the SATA 118. In a case of a disk cache query, the CPU 112 can return a data base lookup status using accesses over 124 to DRAM 126, without using SATA 118. Using the SATA-disk connection 120, the data is retrieved by the SATA 118 and sent to CPU 112. This data retrieved from the disk is shown in the current figure as disk data 122. CPU 112 passes the disk data 122 via CPU-DRAM connection 124 to DRAM 126 for temporary storage and processing. The CPU 112 (slave thread 114) retrieves a portion of the disk data as a data block 128 from the DRAM 126 via the CPU-DRAM connection 124 and processes the data block 128 into network packets, shown in the current figure as packed data 130. The packed data 130 is stored via the CPU-DRAM connection 124 back onto the DRAM 126. The CPU 112 now retrieves the packed data as network packets 131 via the CPU-DRAM connection 124 and passes the network packets 131 to the NIC 140. NIC 140 transmits the network packets 131 as transmitted data 132 via network 106 to the master thread 100 on client 102.

While a typical case is described having the master thread 100 on a client 102 remote from the server 108, one skilled in the art will realize that the master thread 100 can be implemented as a module in other locations, such as on server 108, on CPU 112, or on another CPU in server 108. For simplicity, a single CPU 112 is shown in server 108. Current server technology typically includes multiple CPUs (processors), and one skilled in the art will realize that CPU 112 represents one or more processors. Slave thread 114 can be implemented as a module on a single CPU, or distributed across multiple CPUs. SATA 118 is one technology used to provide access (interface, data transfer) between the CPU 112 and disk 110. Other technologies can be used additionally or alternatively to provide equivalent SATA capability, such as SAS. Similar to the use of CPU 112, as described above, and DRAM 126, as described below, in the context of this document disk 110 is used for simplicity to refer to one or more storage devices. Typically, disk 110 includes one or more hard drives operationally connected to server 108 via an appropriate interface (such as SATA 118).

In the context of this document, DRAM 126 generally refers to a system of one or more DRAMs. Typically, DRAM 126 includes a plurality of DRAMs, shown in the current figure as DRAM-A 126A, DRAM-B 126B, up to and including DRAM-N 126N, where “N” is an integer number greater than zero. CPU-DRAM connection 124 includes one or more connections between CPU 112 and DRAM 126, typically a plurality of parallel connections. Conventional DRAM 126 is typically shared among multiple processors and CPUs. As a result, the number of connections implemented in CPU-DRAM connection 124 from an individual CPU to an individual DRAM is limited. For example, a typical CPU-DRAM connection 124 is to have six connections from the CPU 112 to each DRAM (126A, 126B, 126N). Conventional DRAM 126 is used for functions such as storing tables allowing data to metadata lookups. In typical state-of-the-art implementations, a CPU assumes that most accesses are to cached data (to the cache, and not to DRAM). As a result of this conventional design, while access to cached data is optimized, access to DRAM is relatively slower (longer times, increased latency). As can be seen from the current example, conventional data retrieval via a CPU requires multiple accesses to DRAM, resulting in relatively long latencies as compared to locally accessing cached data.

Network 106 can be any network appropriate for a remote storage application, including but not limited to the Internet, an internet, a local area network (LAN), wide area network (WAN), wireless LAN (WLAN) such as WiFi, etc.

While the current exemplary case describes operation for data retrieval, based on this description one skilled in the art will understand the complementary case of data storage, and be able to implement embodiments for data storage.

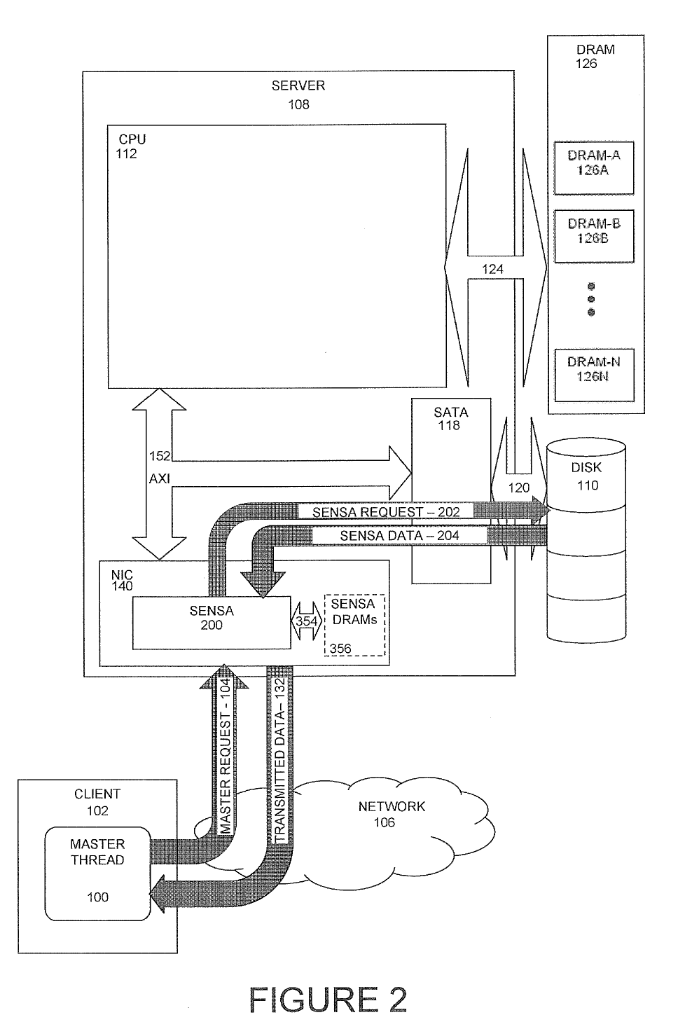

Refer now to FIG. 2, a high-level diagram of an exemplary Software Enabled Network Storage Accelerator (SENSA) implementation. In this exemplary implementation, a SENSA slave storage co-processor module (or simply SENSA co-processor) 200 is shown in a preferred implementation on the NIC 140. Alternatively, the SENSA co-processor 200 can be implemented after the NIC 140, in other words, implemented between the NIC 140, the CPU 112, and the SATA 118. Alternatively, the SENSA co-processor can replace the NIC, obviously requiring additional NIC features to be integrated into the basic SENSA module. SENSA can be implemented as a system on a chip (SoC). SENSA co-processor 200 communicates via SENSA to SENSA DRAMs link 354 to SENSA DRAMs 356.

A significant feature of the SENSA co-processor 200 is implementation of innovative event processing. SENSA can serve as an event processor, where events can come internally from server 108, or externally from network 106 (for example as network packets). In the context of this document, the term “event” generally refers to information received by SENSA, and more specifically to a payload of a received packet, the payload explicitly or implicitly requesting the performance of an associated task. Typically, a task includes an interleaved sequence of routines, including software/firmware routines and hardware engine routines. The event can be at least a portion of the payload, for example part or all of a received packet payload, in the context of this document referred to for simplicity as “payload” or “event”. After receiving an event, SENSA processes/responds to the received event, referred to as SENSA processing the event or referred to as simply SENSA event processing. As will be obvious to one skilled in the art, while the term “event” can refer to a conceptual occurrence (something that happened), the physical instantiation of the event is as a payload of bytes of information representing the occurrence. Event processing should not be confused with conventional packet processing. Accelerated packet processing can include techniques to receive and route network data packets without using a server's CPU. However, the problems and implementations of packet processing are not comparable with the challenges of event processing. Packet processing typically includes operations like forwarding, classification, metering, and statistics gathering of network packets. Packet processing, or packet filtering, includes passing or blocking packets at a network interface based on source addresses, destination addresses, ports, or protocols of the packet being processed. Packet processing includes examining the header of each packet based on a specific set of rules, and based on the specific set of rules, deciding how to process, (handle or filter) the packet. Packet processing options include preventing the packet from passing (called DROP) or allowing the packet to pass (called ACCEPT). In other words, packet processing relates to routing packets based on header information of each packet.

In contrast to packet processing, event processing generally refers to processing the payload, or internal data of the packet. In other words, packet processing deals with external packet information (such as source and destination addresses), while event processing refers to internal packet information. For example, such as notification of a significant occurrence that needs to be handled, requests for data (retrieving), and receiving of data (requests for storing). Event processing includes tracking and analyzing (processing) single pieces or streams of information (data) about things that happen (conceptual events). A conceptual event can be any identifiable occurrence that has significance in the context of a specific application. A conceptual event can be a semantic construct associated with a point in time that may result in an instance of processing of state transitions on the part of the receiver. An event can represent some message, token, count, pattern, value, or marker that can be recognized within an ongoing stream of monitored inputs.

Examples of events include, but are not limited to:
Network traffic:
   Packet received from the network and sent to the host as-is (normal NIC operation).
   Packet is pushed by the host via PCIe and is sent over the network by SENSA (normal NIC operation).
   Protocol signaling packet is received from the network to be terminated in the SENSA stack (for example, TCP ACK).
SENSA internal database (DB) related:
   DB search/update—Memcached lookup/write in the tables kept in DRAMs 356
   Maintenance operation by the host—PCIe transactions.
   Internal maintenance operation like DB scrubbing—initiated by SENSA internal timers.
Disk read/write accesses from remote client to local disk:
   Request—FCoE, iSCSI, or similar operation coming from the network
   Response—read data back arriving from local SAS/SATA over PCIe and is sent to the remote client in form of FCoE, iSCSI or similar packet.
Complex Events:
   Stock exchange market data quote arrives at SENSA in form of UDP packet, then the stock exchange market data is processed by SENSA firmware for relevancy and trading opportunity. If relevant, the stock exchange market data is sent to the host for further processing. This operation includes market data messages filtering, preprocessing, normalizing, etc.
   Stock exchange market data quote can also be fully processed by SENSA resulting in generation of a new event, for example, a new trading order being sent to the exchange.

In general, the master thread 100 requests data (master request 104) via a network 106 from a remote server 108 having associated storage (disk 110). The master request 104 is received at the server 108 by a NIC 140 and intercepted for handling by one or more SENSA co-processor 200 components. In the above described conventional processing, master request 104 is passed from the NIC 140 to the CPU 112. In contrast, in some implementations, the master request 104 is handled by one or more SENSA co-processor 200 components and a SENSA request 202 alternate path used from the SENSA co-processor 200 to the SATA 118 or to a local database kept in SENSA local internal or SENSA DRAMs 356 memory. Use of the SENSA request 202 alternate path avoids the time, processing resources of the CPU 112, and the memory resources of the DRAM 126 of conventional processing of master request 104. After data has been retrieved from disk 110 or the database, the SATA 118 can send the retrieved data as SENSA data 204 to the SENSA co-processor 200. The received SENSA data 204 is then transmitted by the NIC 140 as transmitted data 132 back to the original requesting master thread 100.

For clarity in FIG. 2, conventional connections such as NIC 140 to CPU 112 and CPU 112 to SATA 118 are not shown.

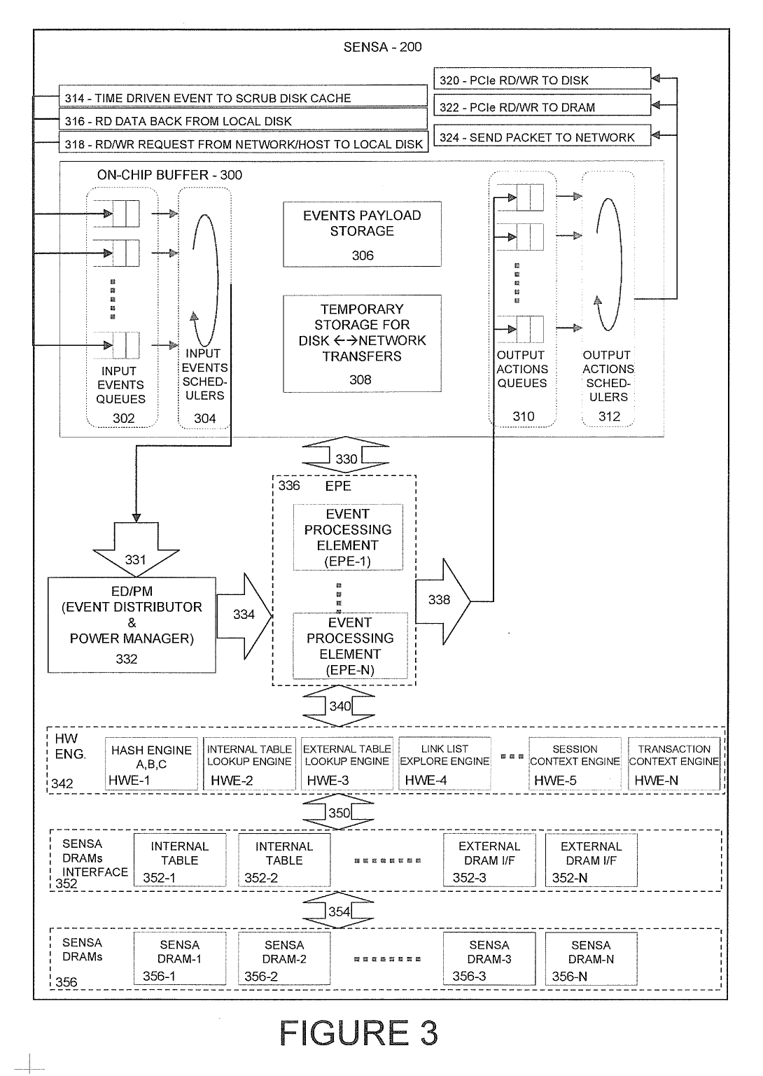

Refer now to FIG. 3, a more detailed diagram of an exemplary Software Enabled Network Storage Accelerator (SENSA) implementation. The SENSA co-processor 200 includes a number of SENSA components that can be implemented individually or in combination.

On-chip buffer 300, also referred to in this document as a “small imbedded buffer”, includes input event queues 302, input events schedulers 304, events payload storage 306, temporary storage 308 for transfers between disk and network, output actions queues 310, and output actions schedulers 312. Inputs to the on-chip buffer include time driven events to scrub disk cache shown as block 314), reading (RD) data back from local disk 110 (shown as block 316), and read/write (RD/WR) requests from network 104/server 108 to local disk (shown as block 318). Outputs from the on-chip buffer 300 include PCIe (PCI Express [peripheral component interconnect express]) read/write (RD/WR) to disk 110 (shown as block 320), PCIe read/write to DRAM 126 (shown as block 322), and sending packets to network/transmitted data 132 (shown as block 324). In the context of this document, input event queues 302 is generally a memory and also referred to as “event queue” and handles event heads, while events payload storage 306 is generally a memory and also referred to as “event buffer” and handles the corresponding event payload tail. In the context of this document, the term “event head” generally refers to the first up to 256 Bytes of an event, and the remaining Bytes of the event (if existing) are referred to as an event tail. Generally, an assumption is that the event head contains sufficient information on which to make a decision how to handle the event. Implementations of input events schedulers 304 include as a single element, multiple elements, and collection of multiple components. Based on this description, one skilled in the art will be able to implement an input events schedulers 304 for a desired application.

As an overview, a received event from input event queues 302 is split in input events schedulers 304 into an event head and event tail. The event head (or simply head) is sent from input events schedulers 304 to event distributor and power manager (ED/PM 332) and then to one of the EPEs in EPE 336. The event tail (or simply tail), if existing, is sent from input events schedulers 304 to events payload storage 306. Typically, the information in the event head is sufficient for processing the received event, otherwise EPE 336 can access via on-chip buffer to EPE link 330 the remaining payload information stored as the event tail in events payload storage 306. After processing by EPE 336, appropriate portions of the event head from EPE 336, new and or additional information from EPE 336, and appropriate portions of the event tail from events payload storage 306 are combined in output actions queues 310. On-chip buffer to EPE link 330 (also referred to as RD/WR access to internal buffer) includes one or more connections between on-chip buffer 300 and EPE 336, typically a plurality of parallel connections or mesh connection. This link allows individual EPEs (EPE-1, EPE-N) in the EPE to read and write data from the various portions of the on-chip buffer 300. For example, reading data from events payload storage 306 and writing data to temporary storage 308.

On-chip buffer to ED/PM (event distributor and power manager) link 331 includes one or more connections from the on-chip buffer 300 to the ED/PM 332, typically a plurality of parallel connections allowing the input events to be communicated to the ED/PM 332.

The event distributor and power manager (ED/PM) 332 module receives events from the input events schedulers 304, and distributes individual events to an individual EPE of EPE 336. The distribution can be a simple round-robin tasks dispatcher, or a more complex algorithm, depending on the specific application.

ED/PM to EPE link 334 includes one or more connections from the ED/PM 332 to EPE 336, typically a plurality of parallel connections allowing the ED/PM to communicate to one or more individual EPE (EPE-1, EPE-N).

In the context of this document, event-processing element (EPE) 336 generally refers to a module system of one or more EPEs. Typically, EPE 336 includes a plurality of EPEs, shown in FIG. 3 as EPE-1, up to and including EPE-N, where “N” is an integer number greater than zero. EPEs are typically symmetrical (identical), and have the same instruction code to execute.

A suggested implementation for EPEs is as an array of identical processors, such as small RISC cores. Preferably, all the EPEs are symmetric and have the same instruction code. Each EPE performs functions including classification of received events, priority decisions, engines arbitration decisions, and main processing functionality. Each individual EPE of a plurality of EPEs processes a single task in run-to-completion manner by running associated firmware. Typically, every new task is served by a corresponding individual EPE of EPE 336. A feature of the SENSA implementation is the offloading from the EPEs of the appropriate operations to corresponding hardware engines (HWE). All EPEs can have access to all HWEs.

The EPE implementation features an increased speed of processing, as compared to conventional event handling, so that no unclassified events are waiting to be serviced (by an EPE). Preferably, the number of individual EPEs in EPE 336 is selected (dimensioned) to be large enough to process input events from input events queues 302, in order to maintain input events queues 302 empty. In other words, after an input event is queued in input events queues 302, the queued input event can more to an EPE without waiting for an EPE to become available.

EPEs have direct load/store access to the various queues and buffers in on-chip buffer 300 (via on-chip buffer to EPE link 330) to manage queues (such as input events queues 302) and buffers (such as events payload storage 306). As queues (such as input events queues 302) in on-chip buffer 300 are typically physically implemented in the same shared memory as memories (such as events payload storage 306 and temporary storage 308), the EPEs have load/store access to the queues, in case such access would be needed.

In an exemplary SENSA implementation, EPE 336 is implemented as 48 individual EPEs (EPE-1 to EPE-N, where N=48) RISC cores, such as available from ARM, MIPS, ARC, Tensillica, and Microblaze.

EPE to on-chip buffer link 338 includes one or more connections from the output of EPE 336 to the output actions queues 310 of the on-chip buffer 300.

EPE to HW engine link 340 includes one or more connections between EPE 336 and hardware engine (HWE) 342. The EPE to HW engine link 340 is typically a plurality of parallel connections, and preferably a mesh network of connections. This link can allow communication (including sending/writing and receiving/reading) between individual EPEs (EPE-1, EPE-N) in the EPE 336 and individual hardware engines (HWE-1 to HWE-N) in the HW engine 342.

In the context of this document, hardware engine (HW engine, HWE) 342 generally refers to a system module of one or more hardware engines. Typically, HW engine 342 includes a plurality of hardware engines, shown in FIG. 3 as HWE-1, up to and including HWE-N, where “N” is an integer number greater than zero. The specific number and type of hardware engines is determined by the specific application for which the SENSA, or specifically the HW engine 342, is designed. Examples of hardware engines include, but are not limited to hash engines (HWE-1), internal table lookup engines (HWE-2), external table lookup engines (HWE-3), link list explore engines (HWE-4), session context engines (HWE-5), and transaction context engines (HWE-N). Hardware engines perform tasks offloaded from the EPEs, such as table lookups, HASH calculations, and other computation intensive operations. Additional exemplary implementations of hardware engines include hardware engines for performing hash SHA-1, hash MD-5, hash AES, link list exploration engine, and session context engine. Each HWE implementation can be instantiated multiple times, such as each of the above types of hardware engines being instantiated four times.

The hardware engines do not deal with scheduling or arbitration of events, but only process requests that are arranged in the HWE input queues (not shown in the figures) by the EPEs. HWE input queues are queues in front of each individual HWE, of requests from EPEs to the HWE, to resolve potential issues of instantaneous HWE oversubscription.

Typically, all individual EPEs send requests from an individual EPE to all hardware engines (HWEs) of HWE 342. The sent request is served by an individual HWE, results of the request returned to EPE 336, and then an individual HWE is available to serve another request from any individual EPE.

HW engine to SENSA DRAMs interface (I/F) link 350 includes one or more connections between HW engine 342 and SENSA DRAMs interface 352. The HW engine to SENSA DRAMs I/F link 350 is typically a plurality of parallel connections, and preferably a mesh network of connections. This link can allow communications (including sending/writing and receiving/reading) between individual hardware engines (HWE-1 to HWE-N) in the HW engine 342 and individual DRAM interfaces (352-1 to 352-N). As described in reference to CPU-DRAM connection 124, typically the number of connections 124 to conventional DRAM 126 is limited, as the DRAMs are shared among a number of CPUs and processors. In contrast, SENSA DRAMs I/F link 350 is a dedicated connection between HW engine 342 and SENSA DRAMs interface 352. As such, SENSA DRAMs I/F link 350 can include a larger number of connections between individual. HW engines and individual DRAM interfaces. In an exemplary implementation, four SENSA DRAMs I/F links 350 provide connection to twelve HWEs 342. While conventional CPU to DRAM connections, such as CPU-DRAM connection 124 can provide connectivity similar to mesh networks, conventional designs are limited due to very long latencies (for example due to multi-layering and L1-L3 caches, in comparison to the current SENSA DRAMs I/F link 350.

In the context of this document, SENSA DRAMs interface 352 generally refers to a system module of one or more interface modules and/or memories. Typically, SENSA DRAMs interface 352 includes a plurality of interfaces, shown in FIG. 3 as 352-1, up to and including 352-N, where “N” is an integer number greater than zero. The specific number, configuration, and use of DRAM interfaces are determined by the specific application for which the SENSA, or specifically the SENSA DRAMs interfaces 352, is designed. Examples of configuration and use of SENSA DRAMs interfaces include, but are not limited to storing internal tables (352-1, 352-2) and external DRAM interfaces (I/F) (352-3, 352-N).

SENSA DRAMs interface to SENSA DRAMs link 354 includes one or more connections between SENSA DRAMs interface 352 and SENSA DRAMs 356. The SENSA DRAMs interface to SENSA DRAMs link 354 is typically a plurality of parallel connections, and preferably a mesh network of connections. This link can allow communications (including sending/writing and receiving/reading) between individual DRAM interfaces (352-1 to 352-N) in SENSA DRAMS interface 352 and between individual DRAMs (356-1 to 356-N) (or more generally individual memories). As described in reference to CPU-DRAM connection 124, typically the number of connections 124 to conventional DRAM 126 is limited, as the DRAMs are shared among a number of CPUs and processors. In contrast, SENSA DRAMs interface to SENSA DRAMs link 354 is a dedicated connection between SENSA DRAMs interface 352 and SENSA DRAMs 356. As such, SENSA DRAMs interface to SENSA DRAMs link 354 can include a larger number of connections between individual SENSA DRAMs interfaces 352 and individual SENSA DRAMs 356.

In the context of this document, SENSA DRAMs 356 generally refers to a system module of one or more memories, normally volatile memory, and typically implemented as DRAM (dynamic random access memory) memory. Typically, SENSA DRAMs 356 includes a plurality of DRAMs, shown in FIG. 3 as 356-1, up to and including 356-N, where “N” is an integer number greater than zero. The specific number, configuration, and use of DRAMs is determined by the specific application for which the SENSA, or specifically the SENSA DRAMs 356 is designed. In an exemplary implementation, each individual DRAM (356-1, . . . , 356-N) has single DRAM channel of 72 bits. Examples of configuration and use of SENSA DRAMs include, but are not limited to storage blocks meta-data, storage blocks cache state, and data base (like SAP HANA) components.

In one implementation, SENSA DRAMs 356 can implement the functionality found in conventional DRAM 126. In this implementation, the use of SENSA DRAMs 356 with the innovative SENSA architecture avoids conventional latency using CPU 112 and corresponding latency of the CPU-DRAM connection 124. SENSA DRAMs 356 can implement conventional tables and interfaces similar to DRAM 126, or can implement new and/or custom tables and interfaces to match the SENSA architecture and operation.

In an alternative implementation, the master thread 100 (or client 102) application can also access the slave 114 (or server 108) for a query in the client's local DRAM database (for example, disk cache). This type of the functionality can also be facilitated by SENSA by searching in the local DRAMs (corresponding to SENSA DRAMs 356) for the corresponding data base record. For example, Memcached or Redis applications. Optionally, SENSA can be used to offload the client operation (for example, on client 102) of searching for the appropriate server (for example, server 108) before sending a request (for example, master request 104).

In general, internal communication fabrics (links) such as on-chip buffer to EPE link 330 and EPE to HW engine link 340 can be implemented in a variety of topologies, including but not limited to serial, parallel, plurality of parallel connections, mesh, and ring. Based on this description, one skilled in the art will be able to implement each link using a topology to satisfy the requirements of the specific application.

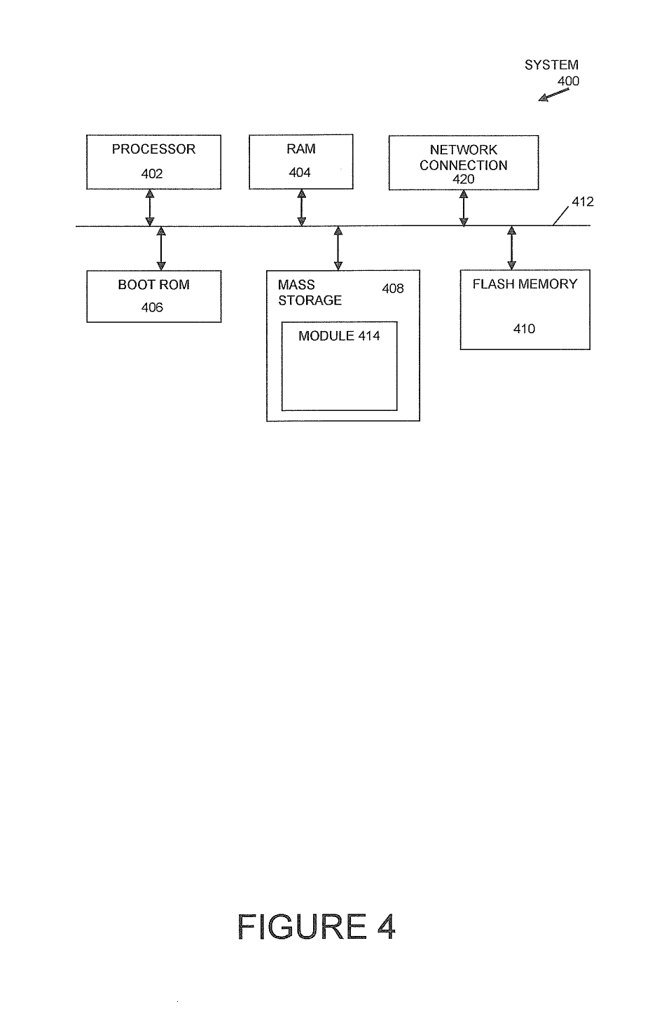

FIG. 4 is a high-level partial block diagram of an exemplary system 400 configured to implement a server 108 of the present invention. System (processing system) 400 includes a processor 402 (one or more) and four exemplary memory devices: a RAM 404, a boot ROM 406, a mass storage device (hard disk) 408, and a flash memory 410, all communicating via a common bus 412. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 402 including but not limited to reduced instruction set computer (RISC) architecture and/or complex instruction set computer (CISC) architecture. A module (processing module) 414 is shown on mass storage 408, but as will be obvious to one skilled in the art, could be located on any of the memory devices.

Mass storage device 408 is a non-limiting example of a computer-readable storage medium bearing computer-readable code for implementing the data retrieval and storage methodology described herein. Other examples of such computer-readable storage media include read-only memories such as CDs bearing such code.

System 400 may have an operating system stored on the memory devices, the ROM may include boot code for the system, and the processor may be configured for executing the boot code to load the operating system to RAM 404, executing the operating system to copy computer-readable code to RAM 404 and execute the code.

Network connection 420 provides communications to and from system 400. Typically, a single network connection provides one or more links, including virtual connections, to other devices on local and/or remote networks. Alternatively, system 400 can include more than one network connection (not shown), each network connection providing one or more links to other devices and/or networks.

System 400 can be implemented as a server or client connected through a network to a client or server, respectively. In an exemplary implementation, system 400 is configured to implement a server 108 of the present invention. In this implementation, processor 402 can function as CPU 112, RAM 404 can function as DRAM 126 or SENSA DRAMs 356, network connection 420 can support master request 104 and transmitted data 132, mass storage 408 can function as disk 110, and common bus 412 can be implemented as internal bus 152. In a less preferred implementation, EPE 336 can be implemented as a computer program (software, computer-readable code). The computer program includes program code stored on a computer-readable storage medium such as mass storage 408 (disk 110).

### DETAILED DESCRIPTION

### First Embodiment

An innovative SENSA component of the general SENSA system is an apparatus and method for hardware (HW) real time operating system (RTOS) optimization for network storage stack applications. In general, this first embodiment provides an innovative implementation for event processing using a multi-core array with coprocessors. The current embodiment is particularly suited for processing complex L4-L7 networking protocols and storage virtualization applications.

A system for hardware RTOS optimization for network storage stack applications includes an array of at least one event processing element (EPE). Each EPE in the array is configured for receiving events. Each of the events has a task corresponding to the event. Each EPE is configured for processing the task in run-to-completion manner by operating on a first portion of the task and offloading a second portion of the task.

In conventional cases of complex system on a chip (SoC) implementations, there are network and storage related tasks that require deterministic performance and hardware resources access. Characteristics of these tasks include:
High rate of events such as:
event per packet coming to/from the network,
event per disk access from external application in the distributed storage systems,
timing driven event, generated by internal timers;
Multiple table lookups involved in the processing thread;
Limited SW processing required for the events treatment; and
High volatility of functionality—protocols and algorithms are constantly emerging.

Typically, network and storage related tasks are addressed by conventional solutions such as:
Software (SW) RTOS running on the main CPU complex—generally using different scheduling algorithms in software to provide deterministic latency (priority preemption, time division, and other algorithms),
Multi-threading—generally an approach where an event is passed from a first execution node performing a first type of processing to subsequent execution nodes performing different subsequent processing,
Hardware co-processors, such as security engines, and
Network offload engines like remote DMA (direct memory access) (RDMA), RDMA over converged Ethernet (RoCE), TCP offload engine (TOE), etc., and
Hardware schedulers—generally a hardware scheduler generating exceptions and interrupts to CPUs in order to have the CPU process events.

The above-described conventional solutions provide lower performance than required to meet the demands of current applications, and/or are limited in flexibility to adapt to the changing requirements of current and future applications. There is therefore a need to provide an apparatus and method for hardware RTOS optimization for network storage stack applications.

An embodiment for providing hardware RTOS optimization for network storage stack applications is an innovative event processing system and method using a multi-core array with coprocessors, as described above in reference to FIG. 3, event processing elements (EPEs 336) and further described here.

In general, this embodiment of a component of the general SENSA system includes an array of event processing elements (EPEs) EPE 336. Each EPE in the array is configured for receiving events. Each of the events is sequentially received and has a task corresponding to the received event.

Preferably, each EPE in the array is identical (symmetrical) and configured with identical firmware instruction code. The array includes at least one EPE, normally at least two EPEs, and typically a multitude of EPEs.

EPE 336 can receive events from conventional sources such as the CPU 112, conventional slave threads (such as slave thread 114), master threads (such as master thread 100), or NIC 140. Optionally and preferably, EPE 336 can be implemented with other SENSA components. For example, when EPE 336 is combined with a SENSA on-chip buffer 300, events can be received from an event distributor 332 based on an input events scheduler 304. The event distributor 332 can be configured with a round robin tasks dispatcher algorithm to distribute events to each EPE in the array of EPEs 336. In a case where EPE 336 is implemented with the on-chip buffer 300, each EPE can have direct load and store access to memories and queues in an on-chip buffer 300, including, but not limited to an events payload storage memory 306 and a temporary storage 308 configured for transfers between disk and network. An implementation technique for optimizing performance of the EPE 336 is to construct the EPE 336 such that the array of EPEs contains a number of EPEs greater than a maximum number of unclassified events waiting to be serviced in an input events queues 302.

Each task (received event) received by an individual EPE of EPE 336 is preferably processed in run-to-completion manner by operating on a first portion of the task and offloading a second portion of the task. Alternatively, the individual EPE can process the entire received task, in other words, not offload a portion of the received task. Typically, an event associated task includes a logical portion and a calculation or I/O intensive portion. Logical portions include extracting fields from an event payload and making processing flow decisions. Logical portions can efficiently be handled by firmware routines in the EPE 336. Calculation or I/O intensive portions include performing lookups in large tables and HASH computations. Calculation or I/O intensive portions can efficiently be handled by hardware engine routines in HWE 342.

Thus, typically, a task includes an interleaved sequence of firmware routines and hardware engine routines. Firmware routines are generally referred to in the context of this document as “first portions”. Optionally, first portions can also include software routines. Hardware engine routines are generally referred to in the context of this document as “second portions”. Tasks normally have at least one firmware routine that is handled by EPE 336. A task can have zero or more hardware engine routines that are offloaded from EPE 336 and handled by HWE 342.

A significant feature of the current embodiment is the architecture and method of the EPEs sharing instructions (firmware routines and hardware engine routines), sharing memories, and providing statefull processing.

Each EPE includes instruction code to execute on that EPE. Preferably the instruction code is firmware and identical on all EPEs. The instruction code is configured to implement operating on at least a first portion of the task. The first portion of the task includes functions including, but not limited to:
Classification of received events. Classification in an EPE generally refers to discovering a type of the event. In other words, analyzing at least a portion of the payload of a received packet header and determining what is an associated task.
Deciding on a priority for each received event.
Deciding how to process the classified event.
Arbitrating decisions regarding hardware processing engines (HWEs).
Main processing functionality—firmware routines for logical portion processing of a task.

Normally a received task includes a second portion that is computationally intensive. While this second portion can be processed by the receiving EPE, preferably processing of this second computationally intensive portion is offloaded to a hardware engine (HWE) module.

The EPE 336 can be connected via a network, such as EPE to HW engine link 340 to a hardware engine (HWE) module 342, as described above with reference to HWE 342 and related components.

The current embodiment is particularly suited for complex system on a chip (SoC) event processing implementations including network and storage related tasks that require deterministic performance and hardware resources access.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

The use of simplified calculations to assist in the description of this embodiment does not detract from the utility and basic advantages of the invention.

To the extent that the appended claims have been drafted without multiple dependencies, this has been done only to accommodate formal requirements in jurisdictions that do not allow such multiple dependencies. It should be noted that all possible combinations of features that would be implied by rendering the claims multiply dependent are explicitly envisaged and should be considered part of the invention.

It should be noted that the above-described examples, numbers used, and exemplary calculations are to assist in the description of this embodiment. Inadvertent typographical and mathematical errors do not detract from the utility and basic advantages of the invention.

It will be appreciated that the above descriptions are intended only to serve as examples, and that many other embodiments are possible within the scope of the present invention as defined in the appended claims.

What is claimed is:

1. A system comprising:
(a) an array of at least two event processing elements (EPEs), each EPE in said array configured for:
(i) receiving events, each of said events having a task corresponding to the event; and
(ii) processing said task in run-to-completion manner by operating on a first portion of said task and offloading a second portion of said task.

2. The system of claim 1 wherein all EPEs in said array are identical.

3. The system of claim 1 wherein all EPEs in said array are configured with identical instruction code for execution.

4. The system of claim 1 wherein each EPE in said array is a RISC core.

5. The system of claim 1 wherein said array of EPEs includes a multitude of EPEs.

6. The system of claim 1 wherein each said EPE is configured to receive single said tasks sequentially.

7. The system of claim 1 wherein each EPE includes firmware configured to implement said operating on said any portion of said task.

8. The system of claim 1 wherein said first portion of said task includes functions selected from a group consisting of:
(a) classification of received events;
(b) deciding on a priority for each received event;
(c) arbitrating decisions regarding hardware processing engines (HWEs); and
(d) main processing functionality.

9. The system of claim 1 further comprising
(b) an event distributor for receiving said events and distributing said events among said EPEs.

10. The system of claim 9 wherein said event distributor is configured with a round robin tasks dispatcher algorithm to distribute events to each EPE in said array of EPEs.

11. The system of claim 9 further comprising
(c) an input events scheduler for:
(A) receiving said events as input;
(B) scheduling processing of said events; and
(C) sending said events as output to said event distributor.

12. The system of claim 1 further comprising:
(b) an on-chip buffer including at least one memory selected from the group consisting of:
(i) an events payload storage memory; and
(ii) a temporary storage configured for transfers between disk and network wherein each EPE has direct load and store access to said on-chip buffer.

13. The system of claim 1 further comprising:
(b) an input events queue
wherein a number of said EPEs in said array exceeds a maximum number of unclassified events allowed to be waiting to be serviced in said input events queue.

14. The system of claim 1 further comprising:
(b) a hardware engine module including an array of a plurality of hardware engines (HWEs) configured for processing requests from said EPEs, to which said second portions of said tasks are offloaded.

15. The system of claim 14 wherein said HWEs are configured for performing functions selected from the group consisting of:
(a) table lookups;
(b) internal table lookups;
(c) external table lookups;
(d) hash calculations;
(e) hash SHA-1;
(f) hash MD-5;
(g) hash AES;
(h) link list exploring;
(i) session context handling; and
(j) transaction context handling;

16. The system of claim 14 further comprising:
(b) a DRAMs (dynamic random access memory) interface module operationally connected to said hardware engine module and including modules selected from the group consisting of:
(i) interface modules;
(ii) external DRAM interfaces;
(iii) memories; and
(iv) internal tables.

17. The system of claim 16 further comprising:
(b) a volatile memory module operationally connected to said DRAMs interface module and including at least one volatile memory.

18. The system of claim 17 wherein said volatile memory is a DRAM module.

19. The system of claim 1 further comprising:
(b) an output actions queues module operationally connected to said array and configured for receiving output from said EPEs.

20. The system of claim 19 further comprising:
(c) an output actions scheduler module operationally connected to said output actions queues module and configured for receiving output from said output actions queues module.

21. A method for processing events comprising the steps of:
(a) providing an array of at least two EPEs;
(b) receiving events, each of the events having a task corresponding to the event; and
(c) for each said task:
(i) assigning said each task to a respective one of said EPEs, and
(ii) processing said each task, by said respective EPE, in run-to-completion manner by operating on a first portion of said task and offloading a second portion of said task.

22. The method of claim 21 wherein each received event is processed by identical instruction code.

23. The method of claim 21 wherein each of the events is received sequentially.

24. The method of claim 21 wherein said first portion of said task includes functions selected from a group consisting of:
(a) classification of received events;
(b) deciding on a priority for each received event;
(c) arbitrating decisions regarding hardware processing engines (HWEs); and
(d) main processing functionality.

25. The method of claim 21 wherein the events are received from an event distributor.

26. The method of claim 25 wherein said event distributor transmits the events based on a round robin tasks dispatcher algorithm.

27. The method of claim 25 wherein the events are received at said event distributor from an input scheduler configured for:
(i) receiving said events as input;
(ii) scheduling processing of said events; and

28. The method of claim 21 wherein said second portion is offloaded to a hardware engine (HWE) module.

29. The method of claim 28 wherein said HWE module is configured for performing functions selected from the group consisting of:
(a) table lookups;
(b) internal table lookups;
(c) external table lookups;
(d) hash calculations;
(e) hash SHA-1;
(f) hash MD-5;
(g) hash AES;
(h) link list exploring;
(i) session context handling; and
(j) transaction context handling;

30. The method of claim 21 wherein processed events are transmitted to an output actions queues module.

31. A computer-readable storage medium having embedded thereon computer-readable code for processing events, the computer-readable code comprising program code for:
(a) providing an array of at least two EPEs;
(b) receiving events, each of the events having a task corresponding to the event; and
(c) for each said task:
(i) assigning said each task to a respective one of said EPEs, and
(ii) processing said each task, by said respective EPE, in run-to-completion manner by operating on a first portion of said task and offloading a second portion of said task.
